(19) United States
(12) Patent Application Publication
(10) Pub. No.: US 2017/0189260 A1
(43) Pub. Date: Jul. 6, 2017

(54) MASSAGING DEVICE

(71) Applicant: Paul CHEN, Vancouver (CA)

(72) Inventor: Paul CHEN, Vancouver (CA)

(21) Appl. No.: 14/987,909

(22) Filed: Jan. 5, 2016

(51) Int. Cl. A61H 7/00

(52) U.S. Cl. CPC A61H 7/001

(57) ABSTRACT

A massaging device includes a shaft having two end portions, two end members attached to the end portions of the shaft, and the end members each include a massaging member, and one or more barrels are slidably engaged onto the shaft and movable relative to the shaft and the end members, and the barrels each also include a massaging member. The barrels each include a bore for engaging with the shaft, and each include a groove formed in the barrel, one of the end members includes a projection slidably engaged with the grooves of the barrels. One of the end members includes a slot, and the barrel includes a protrusion for slidably engaging with the slot of the end member.

### BACKGROUND OF THE INVENTION

1. Field of the Invention

The present invention relates to a massaging device, and more particularly to a massaging device including an improved and simplified structure or configuration that may be easily and quickly made or manufactured or assembled by the workers and including an adjustable structure or configuration for adjusting the arrangement of the massaging members and for adjusting the massaging effects to the users.

2. Description of the Prior Art

Typical massaging devices comprise a relatively harder or stronger inner housing, and a relatively softer or resilient outer layer for selectively contacting or engaging with the users and for massaging purposes.

For example, U.S. Pat. No. 4,807,603 to Yasui discloses one of the typical massaging devices also comprising a relatively harder or stronger inner housing having a cylindrical shape, and a relatively softer or resilient outer layer for selectively contacting or engaging with the users and for massaging purposes.

However, the outer layer includes a smooth outer peripheral structure or contour that may not be frictionally contacted or engaged with the users such that the users may not be massaged with the typical massaging devices.

U.S. Pat. No. 8,888,808 to Park discloses another typical massaging device comprising a planar base member having a number of projections or protrusions extended outwardly therefrom for frictionally contacting or engaging with the users and for massaging purposes.

However, the projections or protrusions extended outwardly from the planar base member, but may not be adjusted relative to the planar base member, and thus may not provide different massaging forces or effects to the users.

The present invention has arisen to mitigate and/or obviate the afore-described disadvantages of the conventional massaging devices.

### SUMMARY OF THE INVENTION

The primary objective of the present invention is to provide a massaging device including an improved and simplified structure or configuration that may be easily and quickly made or manufactured or assembled by the workers.

The other objective of the present invention is to provide a massaging device including an adjustable structure or configuration for adjusting the arrangement and/or the position of the massaging members and for adjusting the massaging effects to the users.

In accordance with one aspect of the invention, there is provided a massaging device comprising a shaft including two end portions, two end members attached to the end portions of the shaft respectively, and the end members each including a massaging member extended therefrom, and a barrel slidably engaged onto the shaft and movable relative to the shaft and the end members, and the barrel including a massaging member extended therefrom for softly and comfortably contacting or engaging with the users and for massaging purposes. The massaging device includes a simplified structure or configuration that may be easily and quickly made or manufactured or assembled by the workers, and includes an adjustable structure or configuration for adjusting the arrangement of the massaging members and for adjusting the massaging effects to the users.

The barrel includes a bore formed therein for slidably receiving and engaging with the shaft. The barrel includes a groove formed therein, the end members each include a slot formed therein, and the barrel includes a protrusion extended therefrom for slidably engaging with the slot of the end member and for guiding or limiting the barrel to move relative to the end member.

One or more barrels may further be provided and slidably engaged onto the shaft and movable relative to the shaft and the end members, and the barrels each include a massaging member extended therefrom, and the barrels each include a groove formed in the barrel for slidably engaging with the protrusion of the barrel and for guiding or limiting the barrel to move relative to the end member.

The shaft includes a chamber formed therein, and the end members each include a stem extended outwardly therefrom and engaged into the chamber of the shaft at the end portions of the shaft respectively. The shaft includes a channel formed in the shaft and communicating with the chamber of the shaft, and the end members each include a rib extended outwardly from the stem for slidably engaging with the channel of the shaft and for guiding and limiting the stems of the end members to move relative to the shaft and for preventing the end members from rotating relative to the shaft.

The end members each may further include a projection provided on the stem for engaging with the shaft and for anchoring or retaining or positioning the stem of the end member to the shaft. The projection is preferably selected from a spring biased projection. The end members each include a cylindrical housing, and the massaging members of the end members are extended from the cylindrical housings respectively.

The shaft includes an oblong hole formed therein, and the barrel includes a key extended therefrom for slidably engaging with the oblong hole of the shaft and for guiding and limiting the barrel to move relative to the shaft and for preventing the barrel from rotating relative to the shaft.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a massaging device in accordance with the present invention;

FIG. 2 is another perspective view similar to FIG. 1, illustrating the operation of the massaging device;

FIG. 3 is an exploded view as seen from one direction of the massaging device;

FIG. 4 is another exploded view as seen from the other direction of the massaging device;

FIG. 5 is a cross sectional view of the massaging device, taken along lines 5-5 of FIG. 1; and

FIGS. 6, 7 are other cross sectional views of the massaging device, taken along lines 6-6, 7-7 of FIG. 2 respectively, illustrating the operation of the massaging device.

### DETAILED DESCRIPTION OF THE PREFERRED EMBODIMENT

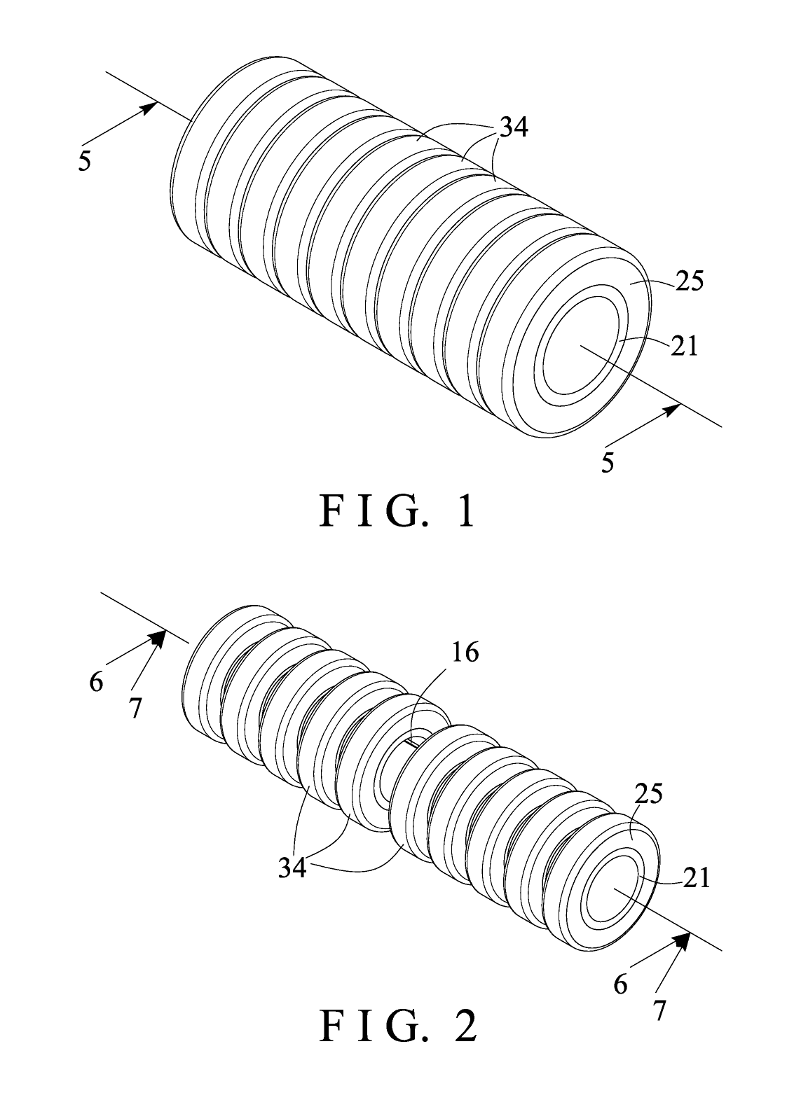

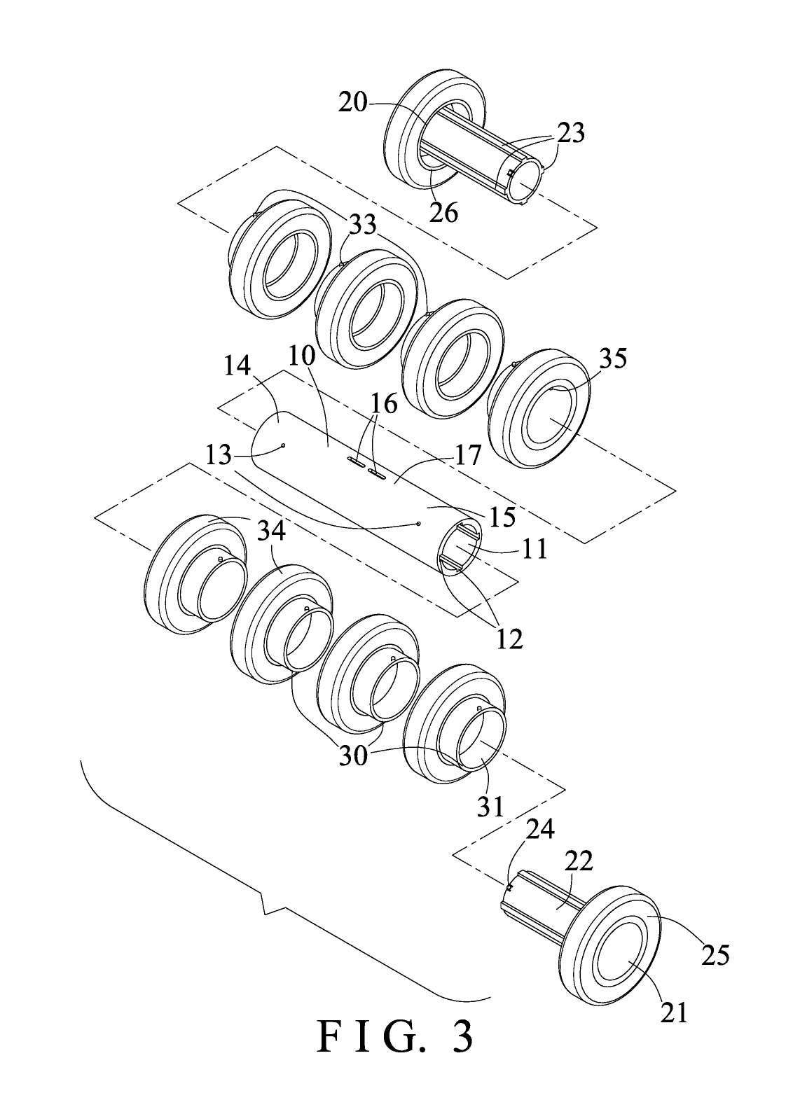

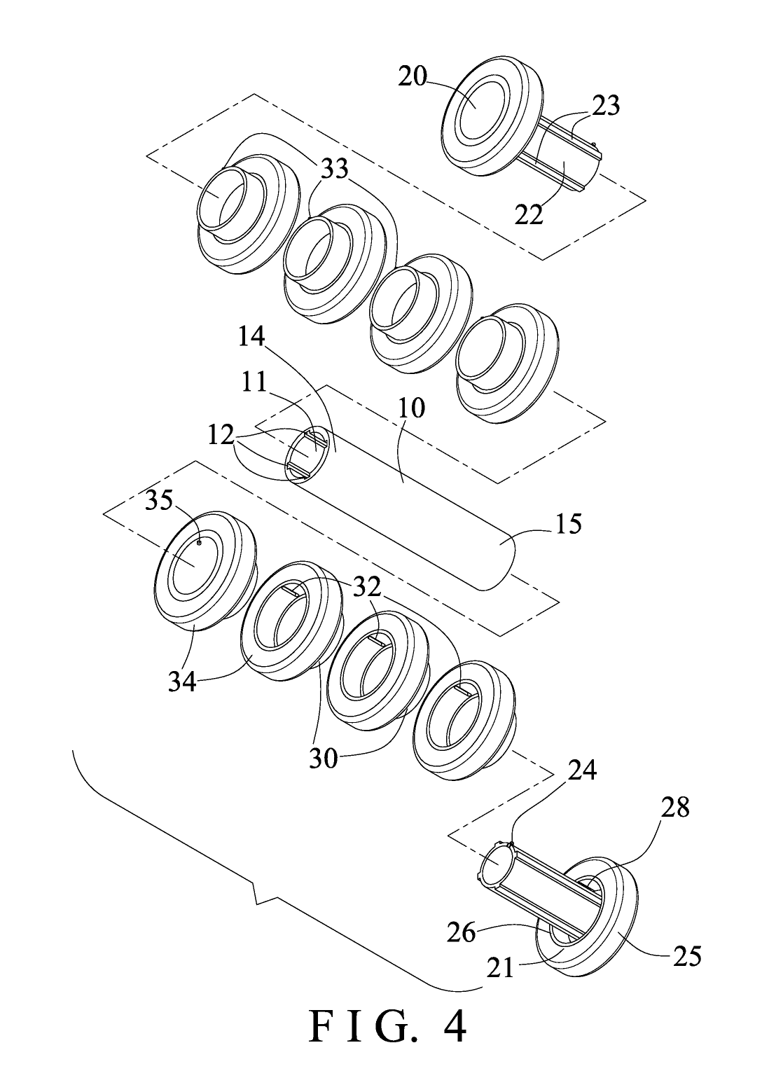

Referring to the drawings, and initially to FIGS. 1-5, a massaging device in accordance with the present invention comprises an inner spindle or shaft 10 including a bore or inner compartment or chamber 11 formed therein (FIGS. 3-4, 6-7), and including one or more (such as four) elongated or longitudinal grooves or channels 12 formed therein (FIGS. 3-4) and communicating with the chamber 11 of the shaft 10, and further including one or more (such as two) orifices 13 formed therein (FIGS. 3, 7) and also communicating with the chamber 11 of the shaft 10. The shaft 10 includes two end portions 14, 15, and includes one or more (such as two) oblong holes 16 formed therein, such as formed in the middle or intermediate portion 17 of the shaft 10.

One or more (such as two) covers or end members 20, 21 are disposed on the end portions 14, 15 of the shaft 10, and each include a stem 22 extended outwardly therefrom and engaged into the chamber 11 of the shaft 10 and/or engaged into and attached to the end portions 14, 15 of the shaft 10 respectively. The end members 20, 21 each include one or more (such as four) elongated or longitudinal protrusions or ribs 23 extended outwardly from the outer peripheral portion of the stem 22 for movably or slidably engaging with the channels 12 of the shaft 10 and for guiding and limiting the stems 22 of the end members 20, 21 to move relative to the shaft 10 and for preventing the end members 20, 21 from pivoting or rotating relative to the shaft 10.

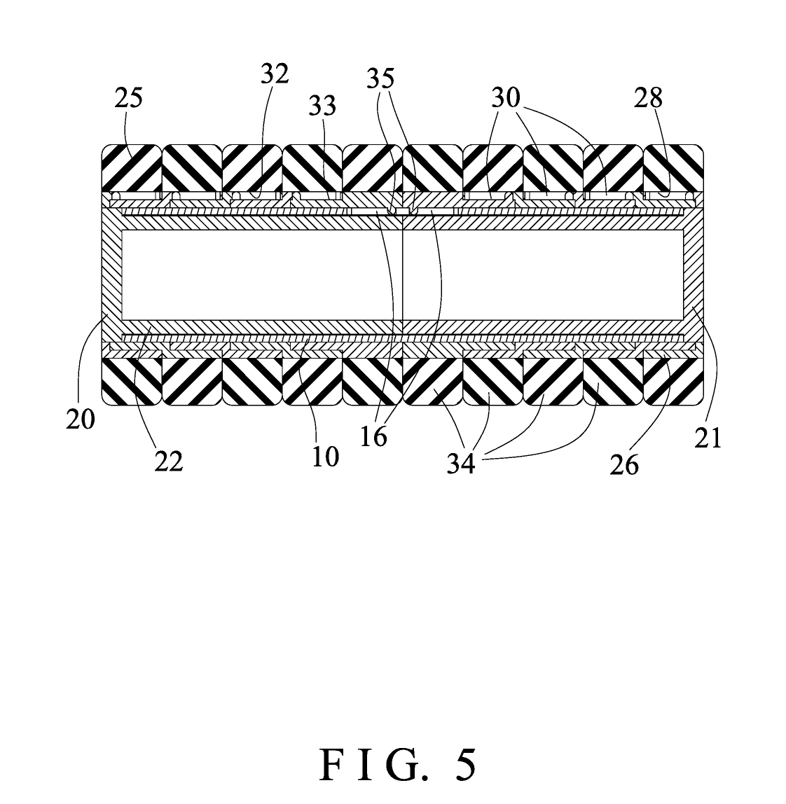

The end members 20, 21 each further include a projection 24, such as a spring biased projection 24 formed or provided thereon for selectively engaging with the orifice 13 of the shaft 10 respectively (FIG. 7) and for anchoring or retaining or positioning the stems 22 of the end members 20, 21 to the shaft 10 at the outwardly extended working position as shown in FIGS. 2 and 6-7. The spring biased projection 24 of the end members 20, 21 may be disengaged from the orifice 13 of the shaft 10 when the stems 22 of the end members 20, 21 are forced and moved into the chamber 11 of the shaft 10 at the compact folding or receiving position as shown in FIGS. 1 and 5.

The end members 20, 21 each further include a massaging projection or massaging member 25 extended radially and outwardly therefrom, such as extended from a cylindrical barrel or housing 26 which is made of a relatively harder or stronger material, such as plastic, wood, metal, synthetic materials or the like, and the massaging member 25 is made of a relatively softer or resilient material, such as plastic, synthetic materials, rubber or the like for softly and comfortably contacting or engaging with the users and for massaging purposes. The end members 20, 21 each include a slot 28 formed in the housing 26 (FIGS. 4-7).

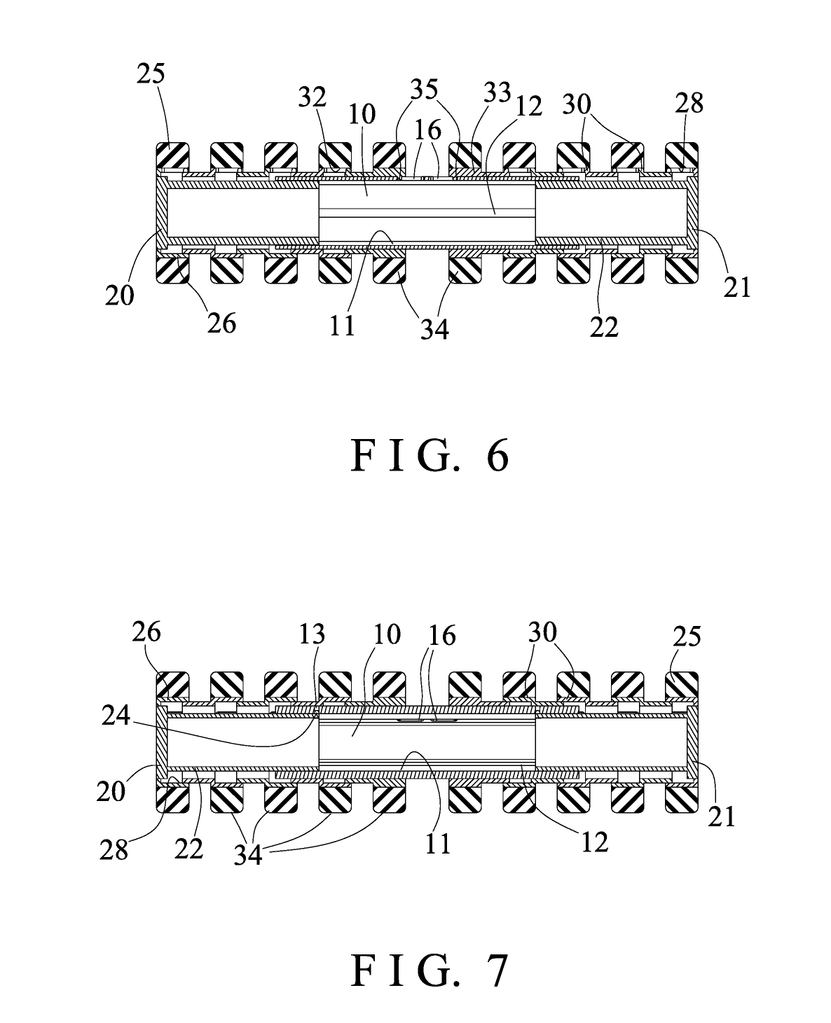

The massaging device further includes one or more cylindrical members or barrels 30 each having a bore 31 formed therein for slidably receiving or engaging with the shaft 10 and for allowing the barrels 30 to be slidably engaged onto the shaft 10. The barrels 30 each further include a groove 32 formed in the barrel 30 (FIGS. 4-6) and communicating with the bore 31 of the barrel 30, and each further include a key or protrusion 33 extended from the barrel 30 (FIGS. 3-6) for slidably engaging with the groove 32 of the barrel 30 and/or the slot 28 of the end members 20, 21 (FIGS. 5-6) and for guiding or limiting the barrels 30 to move relative to the shaft 10 and the end members 20, 21 and for allowing the barrels 30 to be moved relative to each other and to be moved relative to the end members 20, 21 (FIGS. 2 and 6-7).

The barrels 30 each further include a massaging projection or massaging member 34 extended radially and outwardly therefrom and made of a relatively softer or resilient material, such as plastic, synthetic materials, rubber or the like for softly and comfortably contacting or engaging with the users and for massaging purposes. It is preferable, but not necessary that the massaging members 34 of the barrels 30 include an outer diameter equal to that of the massaging members 25 of the end members 20, 21. One or more (such as two) of the barrels 30 each may further include a key 35 extended therefrom for slidably engaging with the oblong holes 16 of the shaft 10 and also for guiding or limiting the barrels 30 to move relative to the shaft 10.

In operation, as shown in FIGS. 1-2 and 5-7, the stems 22 of the end members 20, 21 may be forced and moved into the chamber 11 of the shaft 10 at the compact folding or receiving position as shown in FIGS. 1 and 5, at this moment, the massaging members 34 of the barrels 30 are positioned and located beside each other for providing a massaging effect to the user. As shown in FIGS. 2 and 6-7, the end members 20, 21 may be moved outwardly relative to the shaft 10 to the outwardly extended working position, and the barrels 30 may also be moved relative to each other and may also be moved relative to the end members 20, 21 for allowing the massaging members 34 of the barrels 30 to be positioned and located or separated away from each other and for providing another massaging effect different from the structure as shown in FIGS. 1 and 5.

Accordingly, the massaging device in accordance with the present invention includes an improved and simplified structure or configuration that may be easily and quickly made or manufactured or assembled by the workers, and includes an adjustable structure or configuration for adjusting the arrangement or the position of the massaging members and for adjusting the massaging effects to the users.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A massaging device comprising:
a shaft including two end portions,
two end members attached to said end portions of said shaft respectively, and said end members each including a massaging member extended therefrom, and
a barrel slidably engaged onto said shaft and movable relative to said shaft and said end members, and said barrel including a massaging member extended therefrom.

2. The massaging device as claimed in claim 1, wherein said barrel includes a bore formed therein for slidably receiving and engaging with said shaft.

3. The massaging device as claimed in claim 1, wherein said end members each include a slot formed therein, and said barrel includes a protrusion extended therefrom for slidably engaging with said slot of said end member.

4. The massaging device as claimed in claim 1 further comprising at least one barrel slidably engaged onto said shaft and movable relative to said shaft and said end members, and said at least one barrel includes a massaging member extended therefrom, and said at least one barrel includes a groove formed in said at least one barrel for slidably engaging with said protrusion of said barrel.

5. The massaging device as claimed in claim 1, wherein said shaft includes a chamber formed therein, and said end members each include a stem extended outwardly therefrom and engaged into said chamber of said shaft at said end portions of said shaft respectively.

6. The massaging device as claimed in claim 5, wherein said shaft includes a channel formed in said shaft and communicating with said chamber of said shaft, and said end members each include a rib extended outwardly from said stem for slidably engaging with said channel of said shaft and for guiding and limiting said stems of said end members to move relative to said shaft and for preventing said end members from rotating relative to said shaft.

7. The massaging device as claimed in claim 5, wherein said end members each include a projection provided on said stem for engaging with said shaft and for anchoring or retaining or positioning said stem of said end member to said shaft.

8. The massaging device as claimed in claim 7, wherein said projection is selected from a spring biased projection.

9. The massaging device as claimed in claim 1, wherein said end members each include a cylindrical housing, and said massaging members of said end members are extended from said cylindrical housings respectively.

10. The massaging device as claimed in claim 1, wherein said shaft includes an oblong hole formed therein, and said barrel includes a key extended therefrom for slidably engaging with said oblong hole of said shaft.
